(19) United States
(12) Patent Application Publication
(10) Pub. No.: US 2012/0234176 A1
(43) Pub. Date: Sep. 20, 2012

(54) AIR CLEANING FILTER COMPRISING KIMCHI LACTIC ACID BACTERIA AND DISINFECTANT AND PROCESS FOR PRODUCING SAME

(76) Inventor: Sung Hwa Lee, Changwon-si (KR)

(21) Appl. No.: 13/505,860

(22) PCT Filed: Aug. 30, 2010
(86) PCT No.: PCT/KR2010/005831

§ 371 Date: Jun. 4, 2012

(30) Foreign Application Priority Data
Nov. 3, 2009 (KR) 10-2009-0105346

(51) Int. Cl. B01D 46/00; B05D 3/02

(52) U.S. Cl. 96/227; 96/226; 427/384; 427/383.1

(57) ABSTRACT

The present invention also relates to an air cleaning filter including a carrier having kimchi lactic acid bacteria and disinfectant coated thereon to have an effect of removing or sterilizing bacteria, fungi, and virus from the air. The present invention also relates to an air cleaning filter further includes fermented Ecklonia cava extract. The air cleaning filter according to the present invention is produced by a method including the step of coating and immobilizing kimchi lactic acid bacteria and disinfectant on a carrier, or the step of coating and immobilizing fermented Ecklonia cava extract on a carrier as necessary. Or, the air cleaning filter of the present invention includes the step of coating a coating solution on the carrier, the coating solution including kimchi lactic acid bacteria, disinfectant, optionally fermented Ecklonia cava extract, and a binder selected from a group including silicon modified acryl resin, silicon modified epoxy resin, urethane resin, acryl resin, and silicon resin, and, the step of drying the carrier coated thus, whereby permitting to clean air effectively by removing or sterilizing bacteria, fungi, and virus from the air.

### TECHNICAL FIELD

The present invention relates to an air cleaning filter comprising kimchi lactic acid bacteria, and more particularly the present invention relates to an air cleaning filter which comprises a carrier coated with kimchi lactic acid bacteria and disinfectant for making effective removal or sterilization of microbes, such as bacteria, fungi, and virus from the air, and a process for producing the same. Or, alternatively, the present invention relates to an air cleaning filter which comprises a carrier coated with kimchi lactic acid bacteria, disinfectant and fermented Ecklonia cava extract, and a process for producing the same.

### BACKGROUND ART

Currently, as interest in the environment is increasing, demand for cleaning the room air is also increasing. Consequently, various air cleaning devices for removing contaminants from the air have been developed and are under development. An air cleaning filter device uses an air cleaning filter which is required to be in various shapes and have various characteristics according to the types and sizes of objects to be removed; and the characteristics of the objects to be removed, and thus, a variety of filters are under development.

Especially, an air cleaning filter is required to have anti-microorganism or bactericidal capability for adequate removal or disinfection of microbes, such as bacteria, fungi, and virus floating in the air in order to obtain a satisfactory air cleaning effect.

On the other hand, it has been studied that the virus, a micro life which can not survive for itself but requires a host essentially, infects the host cell, parasitizes at the host, and reproduces itself according to its genetic information in a large amount. That means that the virus is different from other lives and has either a DNA or RNA at a nucleic acid in a cell. The typical examples of RNA viruses are an influenza virus, Ebola virus, AIDS virus, and so on. Since it is known that the RNA viruses make mutation 100,000 to 10,000,000 times easier than the DNA viruses, the prophylaxis of the infection of these RNA viruses is very difficult. Particularly, the influenza A (H1N1) virus, generally called as a new kind of influenza'has a new H1N1 type genome structure different from an existing epidemic influenza virus because it is, for example, born a new kind of virus of swine influenza due to a human influenza virus adapted to a swine host and mixed with an already existing swine influenza virus.

If the new kind of influenza virus would be combined with an avian influenza virus in the swine host by means of gene swapping and thus generate another new kind of virus, then the global infection could be caused by it. It is, also, reported that a human being could also be infected with the above new kind of virus, and even a human being to a human being infection would be very easy, too. With regard to the viral infection, it is also known that the kimchi lactic acid bacteria have a function to cut off a viral infection passage to a human body cell to suppress the virus.

Meanwhile, it also has been studied that a Korean traditional food kimchi, prepared from many kinds of materials, enables to maintain a balance of nutrients. Kimchi is also known for its antibacterial activity, anti-inflammatory, and even anti-cancerous activity, since it comprises many kinds of antibiotics including allicin and a large amount of lactic acid bacteria influencing to metabolic activity of intestinal flora.

Moreover, according to the result of recent studies, since the kimchi lactic acid bacteria is effective for treatment of viral disease, such as the avian influenza and the new kind of influenza A (H1N1 virus), interest in Koreans traditional food kimchi becomes higher and higher.

### DISCLOSURE OF INVENTION

### Technical Problem

An object of the present invention is to provide an air cleaning filter in which kimchi lactic acid bacteria and a disinfectant are used for removal or sterilization of microbes, such as bacteria, fungi, and virus from the air. Or, alternatively, an object of the present invention is to provide an air cleaning filter in which kimchi lactic acid bacteria, a disinfectant and fermented Ecklonia cava extracts are used for removal or sterilization of microbes, such as bacteria, fungi, and virus from the air.

Another object of the present invention is to provide a process for producing an air cleaning filter comprising a carrier coated with kimchi lactic acid bacteria and a disinfectant for removal or sterilization of microbes, such as bacteria, fungi, and virus from the air. Or alternatively, another object of the present invention is to provide a process for producing an air cleaning filter comprising a carrier coated with kimchi lactic acid bacteria, a disinfectant and fermented Ecklonia cava extract for removal or sterilization of microbes, such as bacteria, fungi, and virus from the air.

### Solution to Problem

To achieve these objects and other advantages and in accordance with the purpose of the invention, as embodied and broadly described herein, an air cleaning filter comprises a carrier coated with kimchi lactic acid bacteria, a disinfectant, and optionally fermented Ecklonia cava extract.

In another aspect of the present invention, a process for producing an air cleaning filter includes the step of coating and immobilizing kimchi lactic acid bacteria, disinfectant, and, optionally fermented Ecklonia cava extract on a carrier. Alternatively, the process for producing an air cleaning filter according to the present invention includes the step of coating a coating solution on the carrier, the coating solution including the kimchi lactic acid bacteria, the disinfectant, optionally the fermented Ecklonia cava extract, and a binder selected from a group including silicon modified acryl resin, silicon modified epoxy resin, urethane resin, acryl resin, and silicon resin; and the step of drying the carrier coated thus.

As a material of the carrier in the air cleaning filter of the present invention, as far as the material carries out its role of air cleaning, any one can be used regardless of kinds, shapes, sizes, and producing methods, without any limitation. For an example, glass fiber, such as ion exchange fiber, cellulose fiber, asbestos fiber; various kinds of organic fibers; and various kinds of inorganic fibers can be used. Also, metal, such as zinc, copper, aluminum; or even plastic can be used. These materials can be used for various purposes according to the properties of the materials.

A shape of the carrier used in the air cleaning filter according to the present invention can also be modified appropriately, such as a honey comb shape, a granule shape, a net shape, a filter paper shape, a cotton shape, a mesh shape, a plate shape, a foam shape, and the like, according to the air cleaning devices to which the carrier is applied, without particular limitation.

The air cleaning filter according to the present invention can be used as, or together with, deodorant filter, such as an activated charcoal filter used in domestic appliance, such as a refrigerator and an air conditioner, HEPA (high efficiency particulate air) filter, and a filter in an air cleaner of a car.

The kimchi lactic acid bacteria used in the present invention may be extracted from kimchi directly, or commercially available without any limitation, regardless of state. For an example, the kimchi lactic acid bacteria can be in the state of any one selected from a group of a Kimchi lactic acid bacteria culture solution, a concentration of the culture solution, an extract of the culture solution, a dried culture solution thereof, and a mixture thereof.

Preferably, the kimchi lactic acid bacteria can be any one selected from a group including Leuconostoc genus Kimchi lactic acid bacteria, Lactobacillus genus Kimchi lactic acid bacteria, Weissella genus Kimchi lactic acid bacteria and a mixture thereof. It is particularly preferable that Kimchi lactic acid bacteria are Leuconostoc genus. It is preferable that Leuconostoc genus Kimchi lactic acid bacteria are any one selected from a group including Leuconostoc citreum, Leuconostoc lactis, Leuconostoc mesenteroides subsp. dextranicum, Leuconostoc mesenteroides subsp. Mesenteroides, Leuconostoc argentinum, Leuconostoc camosum, Leuconostoc gellidum, Leuconostoc kimchii, Leuconostoc inhae, Leuconostoc gasicomitatum, and a mixture thereof. It is preferable that the Lactobacillus genus Kimchi lactic acid bacteria are any one selected from a group including Lactobacillus brevis, Lactobacillus acidophilus, Lactobacillus bulgaricus, Lactobacillus plantarum, Lactobacillus kimchii, Lactobacillus plantarum, Lactobacillus curvatus subsp. curvatus, Lactobacillus sakei sibsp. sakei and a mixture thereof. It is also preferable that the Weissella genus Kimchi lactic acid bacteria are any one selected from Weissella koreensis, Weissella hanii, Weissella kimchii, Weissella soli, Weissella confusa, and a mixture thereof.

It is preferable that kimchi lactic acid bacteria used in the present invention are in a form of a lactic acid bacteria culture extract.

As disinfectant used in the present invention having antibacterial, antifungal and antiviral activity, any form and/or kind of disinfectant can be used without particular limitation as far as the disinfectant is harmless to a human body. It is preferable that disinfectant is any one selected from a group including sodium desoxycholate, glutaldehyde and quaternary ammonium, and more preferably, glutaldehyde. Sodium desoxycholate has an effect in which sodium desoxycholate gives influences to a cell membrane to suppress cell growth, and glutaldehyde has an effect in which glutaldehyde connects between proteins to set enzymes, thereby making activity of the protein poor. Quarternary ammonium raises pH, and thus, makes a living condition of the bacteria unfavorable.

The air cleaning filter according to the present invention further includes fermented Ecklonia cava extract. Fermented Ecklonia cava extract includes dieckol component of a phlorotannin group which has an excellent antibacterial/anti-inflammatory activity and has been used for a long time. In the present invention, after mixing Ecklonia cava and distilled water, the mixture is pulverized with a homogenizer, sterilized by a steam high pressure sterilizer at 121° C. for 15 minutes, left at a room temperature until cooled down, and fermented in a shake culture at 30° C. Then, methanol is added to the Ecklonia cava fermented thus, stirred and extracted in a mantle for 3 hours for three times repeatedly, filtered, and concentrated under vacuum in a 60° C. isothermal water tank with a rotary vacuum vaporizer, and an extract component thereof is vaporized to the maximum, to obtain the fermented Ecklonia cava extract powder.

The air cleaning filter of the present invention is produced by a process including the step of coating and immobilizing kimchi lactic acid bacteria and disinfectant on a carrier. If necessary, the air cleaning filter of the present invention is produced by a process including the step of coating and immobilizing the kimchi lactic acid bacteria, the disinfectant and the fermented Ecklonia cava extract on the carrier, at a time or in succession.

The air cleaning filter of the present invention can be produced by a process including the step of spraying a solution (coating solution) to a carrier or dipping the carrier in the coating solution including the kimchi lactic acid bacteria, the disinfectant, optionally fermented Ecklonia cava extract, and a binder selected from a group including silicon modified acryl resin, silicon modified epoxy resin, urethane resin, acryl resin, and silicon resin. Optionally, the coating solution can further include metal. The metal can be Ag, Cu and Zn, and can be used individually, or as mixture thereof, preferably with about 1 v % to 5 v %.

The air cleaning filter according to the present invention can be produced by coating kimchi lactic acid bacteria and disinfectant, or kimchi lactic acid bacteria, disinfectant and a fermented Ecklonia cava extract on a carrier directly. Or, the air cleaning filter according to the present invention can be produced by coating a coating solution on a carrier by spraying or dipping after preparing the coating solution. The step of coating and immobilizing the kimchi lactic acid bacteria and disinfectant, or kimchi lactic acid bacteria, disinfectant, and fermented Ecklonia cava extract on a carrier in the air cleaning filter can be performed by a method known in this field of art. Depending on cases, it is required to change the kimchi lactic acid bacteria and disinfectant, or kimchi lactic acid bacteria, disinfectant and fermented Ecklonia cava extract to a state suitable for coating depending on properties of the carrier. In order to immobilize the kimchi lactic acid bacteria and disinfectant, and optionally fermented Ecklonia cava extract on the carrier, a chemical or physical immobilizing technology suitable for the purpose of use can be used.

In another method for producing an air cleaning filter in which the kimchi lactic acid bacteria, disinfectant and, optionally, fermented Ecklonia cava extract is coated on a carrier, a coating solution is prepared by mixing the kimchi lactic acid bacteria, disinfectant and, optionally, fermented Ecklonia cava extract with a binder, such as silicon modified acryl resin, silicon modified epoxy resin, urethane resin, acryl resin and silicon resin, and the coating solution prepared thus is coated on a surface of the carrier in an air cleaning filter by spraying or dipping. There is no particular limitation in the method for preparing the coating solution as far as the kimchi lactic acid bacteria, disinfectant and, optionally, fermented Ecklonia cava extract can be mixed with the binder enough to be coated on the surface of the carrier. It is preferable that a coating solution consists of 3 v % to 10 v % of kimchi lactic acid bacteria, 0.05 v % to 3 v % of disinfectant, 0.5 v % to 10 v % of fermented Ecklonia cava extract, and 85 v % to 95 v % of the binder and water in view of mixing and coating. In this instance, the binder and water has 20 v % to 30 v % of the binder and 70 v % to 80 v % of the water. In above composition, if a ratio thereof is too high, coating is difficult, and if too low, a performance can be poor. Depending on cases, metal may be further added. The metal can be Ag, Cu and Zn, and can be used individually, or mixed, and an amount of the metal can be about 1 v % to 5 v % in the composition.

In the producing method of the present invention, before the step for coating with kimchi lactic acid bacteria, disinfectant, and fermented Ecklonia cava extract and the like on a carrier, the step for washing the carrier to be used with appropriate washing water or drying the carrier washed thus by heat treatment can be added. Depending on cases, it is preferable that oil stuck to a surface of the carrier of metal or the like during production or storage is removed therefrom. In a case the carrier is dried, a drying period and temperature can be adjusted according to a shape, a kind and a size of the carrier to be used. Moreover, after coating kimchi lactic acid bacteria, disinfectant, and fermented Ecklonia cava extract on the carrier, the step for drying the carrier coated thus can be included.

The air cleaning filter produced according to the present invention is cut to a required size for use as the air cleaning filter of an air cleaning device. The air cleaning filter produced according to the present invention can be used, not only individually within the same product, but also together with a related art air cleaning filter, deodoring filter, and the like. Thus, the air cleaning filter of the present invention can be used widely, in domestic or office air cleaning devices where the air cleaning filter is required, and in automobiles, refrigerators, air conditioners, and other domestic appliances.

### Advantageous Effects of Invention

The present invention has following advantageous effects.

The air cleaning filter according to the present invention having the kimchi lactic acid bacteria, disinfectant, and fermented Ecklonia cava extract coated thereon can effectively clean up microbes, such as bacteria, fungi, and virus from the air by disinfecting and sterilizing the microbes. Especially, the air cleaning filter according to the present invention can provide a safe and efficacious antiviral effect against the avian flu virus, the human influenza virus, and the new kind of influenza virus owing to the kimchi lactic acid bacteria and the fermented Ecklonia cava extract.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

1. Production of an Air Cleaning Filter

After mixing 30 g of Ecklonia cava with 600 ml of distilled water, the mixture is pulverized with a homogenizer, sterilized by a steam high pressure sterilizer at 121° C. for 15 minutes, left at a room temperature until the mixture is cooled down, and fermented for 3 days in a shake culture at 30° C. Then, 6 liters of methanol is added to the Ecklonia cava fermented thus, stirred and extracted in a mantle for 3 hours for three times repeatedly, filtered, and concentrated under vacuum in a 60° C. isothermal water tank with a rotary vacuum vaporizer, and an extract component thereof is vaporized to the maximum, to obtain 24 g of fermented Ecklonia cava extract powder.

Coating solutions are prepared each to include the fermented Ecklonia cava extract; Leuconostoc citreum, which is kimchi lactic acid bacteria culture solution extract commercially available; glutaldehyde; metal in which Ag, Cu, and Zn form a metal sol at a ratio of 1:1:2; silicone modified epoxy resin binder comprising 10% epoxy resin and 90% silicone resin; and distilled water, according to sets of the composition in the following table 1.

Units in the table 1 are v %.

TABLE 1

| | | | | | | Distilled |
|---|---|---|---|---|---|---|
| | 1* | 2* | 3* | Metal | Binder | water |
| Embodiment 1 | 5 | 1 | — | 1 | 25 | 68 |
| Embodiment 2 | 5 | 1 | 2 | 1 | 25 | 68 |

1*: Kimchi lactic acid bacteria culture solution extract
2*: Glutaldehyde
3*: Fermented Ecklonia cava extract

A Jabra type filters of an electrostatic non woven fabric is dipped in each of the coating solutions of above sets of the composition for two minutes, respectively. The filters dipped thus are removed from the coating solutions, left at a room temperature for 30 to 60 minutes (to let the coating solutions flow down), and dried at 70° C. for 60 minutes to fabricate filter samples, respectively.

2. An Antibacterial Test of the Filter against Staphylococcus Aureus

(1) Preparation of a Test Piece

A pre-incubated S. aureus solution (10⁹ cfu/m1) is diluted and inoculated to a 100 ml of sterilized neutral solution (0.2% culture broth, 0.5% NaCl) in a conical flask so as to be 10⁵ cfu/ml.
30 test samples each with 1.0×1.0 cm square are prepared, and the obtained neutral solution above is placed in the test samples. These are called as anti-bacteria processed test pieces.
30 filters which are not subjected to any anti-bacteria process are provided with sizes the same with the test samples, respectively, and placed in 100 ml of the neutral solution above in order to provide the control group.
As the control group, after diluting a flask prepared by using a physiological salt solution and shaking well, 1 ml of the obtained solution is taken and an initial number of bacteria is counted by a mixed dilution plating incubation method (pour plate).
The filter and the conical flask, having the S. aureus inoculated thereto thus and shaken at 35° C. shaking incubator at 150 rpm, are made to react for 24 hours.
The S. aureus made to react with the filter for 24 hours are diluted in decimal notation, 1 ml of diluted solution thereof is placed in a sterilized plate, and is incubated in a mixed dilution plate by using nutrient agar.
The bacterial plate is incubated at a 37° C. incubator for 18 to 24 hours.

(2) Test Result

After 24 hours, the colonies of the S. aureus are counted and the following table 2 shows a result of the count.

TABLE 2
Antibacterial performance on S. aureus

| | | Time (hours) | |
|---|---|---|---|
| | | 0 | 24 |
| Control group | No. of bacteria | 2.2 × 10⁴ | 1.1 × 10⁹ |
| | Reduction ratio | | |
| Embodiment 1 | No. of bacteria | 2.2 × 10⁴ | 7.7 × 10² |
| | Reduction ratio | | 99.9% |
| Embodiment 2 | No. of bacteria | 2.2 × 10⁴ | 1.6 × 10³ |
| | Reduction ratio | | 99.9% |

3. Anti-Fungus Rate Test of the Filters on Aspergillus Niger

In order to determine an antifungal effect of the filters, anti-fungus rate tests are performed for the filters of embodiments 1 to 2 according to JIS Z 2911 (Antifungal test method).

As a result of the tests, both embodiments 1 and 2 show“0”. In this instance, “0”denotes no mycelia growth, “1” denotes mycelia growth being less than ⅓ of an entire area, and “2” denotes mycelia growth being more than ⅓ of an entire area.

4. Antiviral Test (Shaking Flask Method) of the Filters on Feline Calicivirus (FCV)

(1) Preparation of a Test Piece
6 test samples are provided, each with a size of 1.0×1.0 cm square, and placed on maintenance media {2% FBS (Fetal Bovine Serum), DMEM (Dulbeco's Modified Eagle's Medium)}, respectively.
FCV diluted to about 10⁵ TCID₅₀/ml is inoculated to the test samples, and reacted at a room temperature for predetermined time periods, respectively.
When the reaction is finished, the virus is diluted at maintenance media (2% FBS, DMEM) in decimal notation.
After removing a growth medium by using an aspirator in a 96 well-plate of single film, the obtained diluted virus is inoculated to 8 wells each by 25 μl.
After adsorbing the virus in 5% CO₂ incubator for 90 minutes at 37° C., 100m1 of maintenance medium is added to each of the wells.
A potency of the virus is determined by making the virus to react with the extract for a predetermined time period, comparing an amount of the virus remained after the reaction to the control group, and calculating TCID₅₀ (tissue culture infectious dose 50) measured from CrFK (Crandel feline kidney) cells.

(2) Result of Test

After visualizing cells dissolved by the virus on a fifth day of virus culture, dilution stage of the well showing more than 50% of CPE is calculated by Reed-Munch method and expressed with Log TCID₅₀. The following table 3 shows a result of the calculation.

TABLE 3
Antiviral performance on FCV

| | | Time (hours) | | |
|---|---|---|---|---|
| | | 5 | 8 | 10 |
| Control group | | 5.01.0 × 10⁵ | 4.53.2 × 10⁴ | 3.53.2 × 10³ |
| Embodiment 1 | TCID₅₀ | 2.171.5 × 10² | 2.171.5 × 10² | 2.01.0 × 10² |
| | Reduction | 99.9 | 99.9 | 99.9 |
| | ratio (%) | | | |
| Embodiment 2 | TCID₅₀ | 3.171.5 × 10² | 2.171.5 × 10² | 2.01.0 × 10² |
| | Reduction | 99.9 | 99.9 | 99.9 |
| | ratio (%) | | | |

As a result of the tests, all of the embodiments show the excellent antiviral performances.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The air cleaning filter comprising the kimchi lactic acid bacteria and disinfectant coated thereon according to the present invention can clean up microbes, such as bacteria, fungi, and virus from the air by sterilizing the microbes, and can provide a safe and effective antiviral effect against the virus that causes the bird flu, the human influenza virus, and the new kind of influenza virus.

1. An air cleaning filter comprising:
a carrier coated with kimchi lactic acid bacteria and disinfectant for removing or sterilizing bacteria, fungi, or virus from the air.

2. The air cleaning filter as claimed in claim 1, further comprising fermented Ecklonia cava extract.

3. The air cleaning filter as claimed in claim 1, wherein the kimchi lactic acid bacteria is any one selected from a group including a Kimchi lactic acid bacteria culture solution, a concentration of the culture solution, an extract of the culture solution, a dried culture solution thereof, and a mixture thereof.

4. The air cleaning filter as claimed in claim 1, wherein the disinfectant is any one selected from a group including sodium desoxycholate, glutaldehyde and quaternary ammonium.

5. A method for producing an air cleaning filter of the claim 1 comprising the step of coating and immobilizing the kimchi lactic acid bacteria and the disinfectant on the carrier.

6. A method for producing an air cleaning filter of the claim 3 comprising the step of coating and immobilizing the kimchi lactic acid bacteria, the disinfectant and the fermented Ecklonia cava extract on the carrier.

7. The method as claimed in claim 5, wherein the step of coating and immobilizing the kimchi lactic acid bacteria and the disinfectant; or the kimchi lactic acid bacteria, the disinfectant and the fermented Ecklonia cava extract on the carrier includes the step of coating a coating solution including the kimchi lactic acid bacteria and the disinfectant; or the kimchi lactic acid bacteria, the disinfectant, the fermented Ecklonia cava extract, and a binder selected from a group including silicon modified acryl resin, silicon modified epoxy resin, urethane resin, acryl resin, and silicon resin on the carrier, and the step of drying the carrier having the coating solution coated thereon thus.

8. The method as claimed in claim 7, wherein the coating solution further includes metal.

9. The method as claimed in claim 5, wherein the kimchi lactic acid bacteria is any one selected from a group including a Kimchi lactic acid bacteria culture solution, a concentration of the culture solution, an extract of the culture solution, a dried culture solution thereof, and a mixture thereof.

10. The method as claimed in claim 5, wherein the disinfectant is any one selected from a group including sodium desoxycholate, glutaldehyde and quaternary ammonium.
